(19) United States
(12) Patent Application Publication
(10) Pub. No.: US 2023/0035773 A1
(43) Pub. Date: Feb. 2, 2023

(54) SELECTIVE COMMUNICATION SYSTEM FOR FREIGHT VEHICLE OPERATION

(71) Applicant: Uber Technologies, Inc., San Francisco, CA (US)

(72) Inventors: Bin Chang, San Francisco, CA (US); Shaosu Liu, San Francisco, CA (US)

(21) Appl. No.: 17/887,126

(22) Filed: Aug. 12, 2022

Related U.S. Application Data
(63) Continuation of application No. 16/009,056, filed on Jun. 14, 2018, now abandoned.

(51) Int. Cl. G06Q 10/08

(52) U.S. Cl. CPC G06Q 10/0833

(57) ABSTRACT

A communication system develops an activity profile for multiple operators, where the activity profile of each operator is based, at least in part, on a recent location of the operator, as well as a set of transport parameters for the current assignment of the respective operator. A candidate set of operators can be matched to an open request, where the determination for each operator of the candidate set is based on the activity profile developed for that operator. When the candidate set of operators is determined, the communication system transmits a communication to at least one operator of the candidate set that identifies the at least one matched request.

### TECHNICAL FIELD

Examples described herein relate to a selective communication system for freight vehicle operation.

### BACKGROUND

Freight vehicles generally comprise of a truck and trailer. While the use of freight vehicles for transportation of goods and services is a critical aspect of society, the manner in which freight vehicles are utilized can be inefficient, due to factors such as lack of communication and centralized management of freight vehicles.

Historically, freight brokers performed the task of matching freight operators to new shipments. Typically, the freight brokers would track freights through their relationship with carriers, and the freight brokers would typically match freight operators to shipments by identifying freight operators who were willing and available to accept new shipments.

In recent years, the number of owner-operated freight vehicles and independent freight operators has increased, as compared to enterprises that manage and operate fleets of freight vehicles. Moreover, the relationship between owner freight operators and corporate freight operators has become more fluid, with corporate freight operators readily engaging owner-operated and independent freight operators as needed. Independent freight operators often operate different freight vehicles for different carriers. Even owner-operators who have their own freight vehicle may leave their freight vehicle at home to operate the freight vehicle of a carrier. As a result of these and other trends, the supply of available freight operations can be disparate concerning availability and preferences or needs of the respective freight operators. Additionally, management of freight operators is often decentralized and subject to competing interests.

### BRIEF DESCRIPTION OF THE DRAWINGS

FIG. 1 illustrates a network computer system for implementing a communication system for freight operators and vehicles.

FIG. 2 illustrates a communication system for freight vehicle operation and assignment.

FIG. 3 illustrates an example method for matching freight operators to shipping requests.

FIG. 4 illustrates a method for matching a freight operator that is detected as being available with an open shipping request.

FIG. 5 illustrates a method for matching an open shipping request to a candidate set of freight operators.

FIG. 6 illustrates a computer system on which one or more examples can be implemented.

FIG. 7 illustrates a computing device for use with one or more examples as described.

### DETAILED DESCRIPTION

According to examples, a freight communication system develops a freight activity profile for multiple freight operators, where the freight activity profile of each freight operation is based at least partially on a recent location of the freight operator, as well as a set of transport parameters for the current shipping assignment of the respective freight operator. A candidate set of freight operators can be matched to an open shipping request, where the determination for each freight operator of the candidate set is based on the freight activity profile developed for that freight operator. When the candidate set of freight operators is determined, the communication system sends a communication to the at least one freight operator of the candidate set that identifies the at least one matched shipping request.

In other examples, a communication system operates to detect an availability event with respect to the freight operator's activities, where the availability event can indicate that the freight operator has completed or is nearing completion of an assigned shipping request. In response to detecting the availability event, the communication system determines a match category designation for the freight operator with respect to at least one open shipping request. The communication system can make a determination to match the freight operator to the at least one open shipping request based on the determined match category designation.

According to examples, a network computer system implements a freight matching service that addresses many shortcomings associated with conventional approaches that match freight operators to shipments. As examples of such conventional approaches, applications have been developed in recent years for mobile computing platforms to facilitate freight operators in finding new shipments (e.g., “loadboard applications”). Loadboard applications publish information about available shipments which a freight operator can contract to load and deliver. Typically, loadboard applications identify the location of new or open shipments, the compensation value of the shipment, and information about the load (e.g., size of load). Some services enable freight operators to search for new shipments based on their current location, or alternatively, based on a manually entered location. When a freight operator uses a loadboard application to find a new shipment, the freight operator can contract for the shipment, either directly or through a service that accompanies the loadboard application. These and similar loadboard applications serve a primary function of aggregating and publishing information about new shipment requests, with the individual freight operator being able to filter results based on location or other criteria (e.g., size of shipment).

Examples recognize that while such conventional approaches (e.g., loadboard applications and services) promote decision-making by the individual freight operator, these applications and services have several shortcomings. Among the shortcomings, freight operators typically have to search the listings of the loadboard applications for new shipments. This is often done as a repeated, manual task that can be difficult to manage, as the freight operator has to drive a freight vehicle when working. Moreover, the freight operator's ability to search all relevant locations may be limited. The loadboard applications and services typically publish available information about available shipments that are ready at the present time, and freight operators contract for them on a first-come-first-serve basis. Examples further recognize that promotion of the first-come-first-serve approach by, for example, conventional loadboard applications, can result in a significant loss of efficiency for freight operators as a whole. The first-come-first-serve approach may result in a new shipment being assigned to a freight operator who incurs some overhead which may be acceptable to that particular freight operator(e.g., deadhead miles to accept the load), may miss another freight operator who would have far less overhead (e.g., freight operator for whom the load would be a backhaul). Additionally, because conventional loadboard applications require significant manual interaction with the freight operator, a freight operator may miss new shipments which would suit the freight operator's needs, because the freight operator was driving at the time when the new shipment became available.

In this regard, conventional loadboard applications and services also reward freight operators by the amount of interaction they have with the application interface. For freight operators to identify suitable shipments, freight operators have to repeatedly search the loadboard applications and services for new shipments, based on their current location (e.g., to catch a new shipment), or their planned location. The level of interaction translates to significant usage of computing resources on both the operator device and on servers which provide the accompanying service.

In contrast to conventional approaches, examples as described generate recommendations, such as notifications, for freight operators, using parameters that are specific to the freight operator, such as the freight operator's current location, route, destination, point of origination, home location or preference. As compared to loadboard applications, the recommendations can reduce the need for the freight operator to interact with the mobile computing device, at least for the purpose of locating new shipments. Such reduced interaction can translate to reduced usage of computing resources on the freight operator device, as well as on servers which communicate with the freight operator's computing device. Moreover, the recommendations that are generated by the network computer system can be tailored parameters of the new shipment and also to parameters of prior or current freight activity of the freight operator. For example, a network computer system may generate a recommendation for a freight operator that is based at least partially on (i) the freight operator's starting location and/or destination for the freight operator's existing shipment, (ii) the freight operator's home location (e.g., where the freight operator may store his or her owner-operated freight vehicle), and/or (iii) the freight operator's preference routes or locations. In this regard, examples provide for recommendations to freight operators that are personalized, to consider recent and current freight activities of the freight operator.

While examples as described can generate recommendations that are personalized for the freight operator, the network computer system can also use the recommendations to prioritize selection of freight operators for individual shipments, based on global objectives such as transport efficiency, decreasing overhead, and/or promoting fairness and interests of freight operators with respect to location and route. To this end, some examples provide for a network computer system to first match a new shipment to a limited number of freight operators (e.g., a candidate set) based on a categorical designation of the freight operators with respect to the new shipment. Specific examples recognize efficiency with respect to use of freight vehicles when new shipments are assigned to freight operators for whom the assignment would represent a backhaul (e.g., the new shipment is near the delivery location of the freight operator's current shipment, and it would return the freight operator to the loading location of the freight operator's current load), a reload (e.g., freight operator can load the new shipment within threshold distance of a destination of a current load) or a relay (e.g., freight operator can load the new shipment at location that is near the current route of the freight operator).

According to examples, the network computer system can prioritize matching of freight operators to new shipments when the new shipments can be designated as a backhaul (e.g., highest priority), a reload (e.g., second highest priority) and/or a relay (e.g., third highest priority) for the respective freight operator. For example, for a given new shipment, 2 of 10 recommendations can be for freight operators for whom the new shipment would represent a backhaul, and another 4 of 10 recommendations can be for freight operators for whom the new shipment represent reloads and relays. In examples, an example network computer system recommends the new shipment to the identified candidate set, such that the new shipment is more likely to be assigned to one of the freight operator's in that set (e.g., based on their response). By selecting a freight operator from the candidate set, the network computer system can introduce a measure of vehicle efficiency associated with backhaul, reload and relay designations, where such efficiency may not otherwise be present in conventional approaches where the new shipment can be accepted by a freight operator who evaluates the shipment on an individual basis.

Additionally, in some examples, the recommendations for new shipments can be generated in response to specific events, such as the network computer system identifying a new (or open) shipment. In such examples, recommendations can be communicated to recipient freight operators in the form of a notification or through generation of application content. In such examples, the recommendations can be provided to the operator devices automatically, thus alleviating the amount of interaction the freight operator may otherwise have with their respective operator device, as compared to conventional approaches which promote searching under the first-come-first-serve approach.

One or more examples described provide that methods, techniques, and actions performed by a computing device are performed programmatically, or as a computer-implemented method. Programmatically, as used, means through the use of code or computer-executable instructions. These instructions can be stored in one or more memory resources of the computing device. A programmatically performed step may or may not be automatic.

One or more examples described can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Some examples described can generally require the use of computing devices, including processing and memory resources. For example, one or more examples described may be implemented, in whole or in part, on computing devices such as servers, desktop computers, cellular or smartphones, and tablet devices. Memory, processing, and network resources may all be used in connection with the establishment, use, or performance of any example described herein (including with the performance of any method or with the implementation of any system).

Furthermore, one or more examples described may be implemented through the use of instructions that are executable by one or more processors. These instructions may be carried on a computer-readable medium. Machines shown or described with figures below provide examples of processing resources and computer-readable mediums on which instructions for implementing examples described can be carried and/or executed. In particular, the numerous machines shown with examples described include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

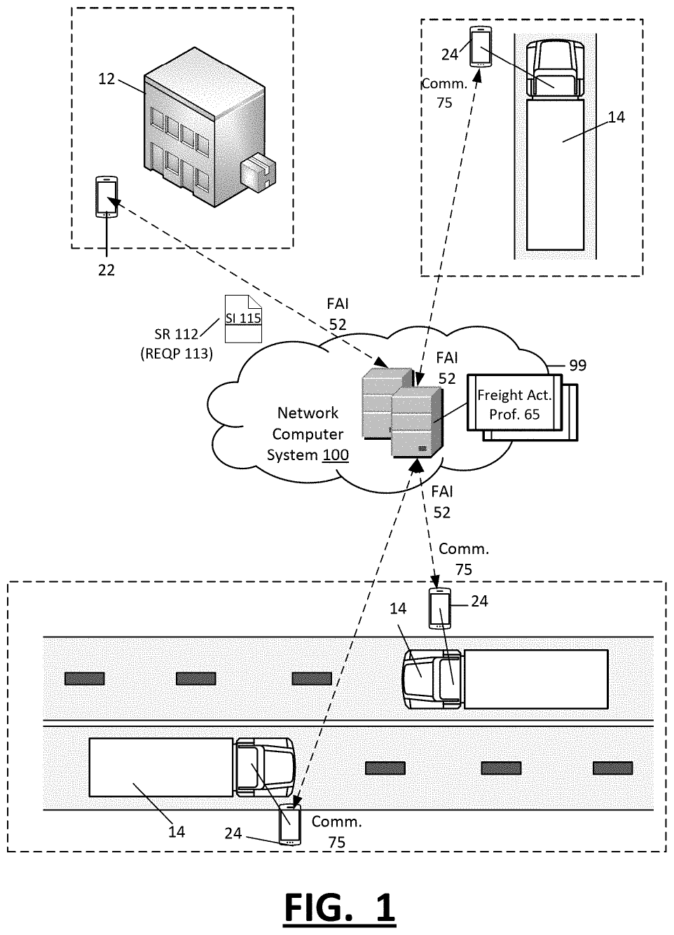

FIG. 1 illustrates a network computer system for implementing a communication system for freight operators and vehicles. According to examples, a network computer system 100 implements a freight matching service to match new shipping requests with freight operators. In particular, the network computer system 100 can develop freight activity profiles for individual freight operators, and further implement a matching protocol that uses the freight activity profiles to assign or recommend open shipping requests to freight operators.

According to examples, the network computer system 100 can be implemented in a variety of computing environments, including as part of a network service provided through one or more servers. The network computer system 100 may be implemented on a server, on a combination of servers, and/or on a distributed set of computing devices which communicate over a network 99, such as the Internet. In some examples, the network computer system 100 is implemented using mobile devices of users, including operator devices 24 and/or shipper devices 22.

Over a given territory, the network computer system 100 communicates with numerous operator devices 24 that are individually located within corresponding freight vehicles 14. In some examples, each freight vehicle 14 includes a truck (or tractor) and trailer, with the trailer being separable from the truck. In variations, each freight vehicle 14 can correspond to any vehicle that is capable of carrying a shipment load. By way of example, freight vehicles can include tractor units (sometimes referred as to as “semis” or “semi-tractors”), flatbed trucks, cargo vans, box trucks, and numerous types of specialized trucks (e.g., tank trucks to carry flammable liquid, refrigerated trucks, etc.).

In some examples, the operator devices 24 correspond to mobile devices of freight operators. For example, at least some of the operator devices 24 can be implemented as a multi-functional messaging and/or telephony device of the freight operator (e.g., feature phone, smart phone, phablet, tablet, ultramobile computing device, etc.). In variations, individual operator devices 24 implement respective service applications which communicate with the network computer system 100. In communicating with the network computer system 100, the individual respective operator devices 24 access geo-aware resources of the computing device, such as a respective satellite receiver (e.g., Global Positioning System (“GPS”)) which determines longitude and latitude of the operator device 24 over repeated intervals. The individual operator devices 24 may also execute the service applications to access other types of data, such as sensor data obtained from an accelerometer, gyroscope, inertial mass unit (“IMU”) or other type of sensor device.

The network computer system 100 programmatically monitors freight operators (or freight vehicles) that are active (e.g., currently transporting a shipment in furtherance of a shipping request) in operating freight vehicles 14 over a given geographical region. In examples, the individual operator devices 24 execute corresponding service applications that cause the respective mobile devices to operate as information inlets and/or outlets for the network computer system 100. As an information inlet, the operator devices 24 transmit freight activity information 52 to the network computer system 100, using one or more wireless networks (e.g., cellular networks). The freight activity information 52 can include sensor information obtained from the respective service application, including location information for the respective freight vehicle 14. In this way, the network computer system 100 can use vehicle data 25, as transmitted from operator devices 24, to track respective freight vehicles 14, including to determine and update the current or recent location of individual freight vehicles over a given geographical region.

As described with some examples, the network computer system 100 can further detect and track activities of individual freight operators using the freight activity information 52. For example, the operator devices 24 can detect and record, via the respective service application, interactions of the individual freight operators with respect to communications of the matching service. Additionally, the operator devices 24 can detect and record, using sensor data (e.g., location information) and/or other information, the occurrence of predefined events, such as the freight operator completing, or nearing completion of a shipping request.

In some examples, the freight activity information 52 can include logging information from corresponding freight vehicles 14. The logging information may be obtained from, for example, the operator devices 24, or alternatively from a resident electronic logging device (ELD) of individual freight vehicles 14. The logging information may identify, for example, information about the operation of the corresponding freight vehicle 14, such as information from which fuel efficiency can be determined. As an addition or variation, the logging information may identify a continuous interval during which the freight vehicle was in operation. Such information may be used to monitor the number of hours during which a freight operator has continuously operated a freight vehicle.

In examples, the network computer system 100 can track shipping requests which are assigned to individual freight operators. In particular, the network computer system 100 can identify parametric information about a current shipping assignment which each freight operator is fulfilling, where the parametric information includes the shipment loading location, loading time (e.g., time interval when load is available for loading), delivery location, and delivery time (e.g., time interval when load is to be delivered at delivery location). For example, when a freight operator accepts a new shipment, the service application may automatically record information about the new shipment, in connection with a profile of the freight operator. In this way, the freight operator can use the service application to develop a profile which can persist as the freight operator operates different freight vehicles.

In variations, the network computer system 100 can determine the current route of the freight operator, and/or predict the route the freight operator will take to fulfill the current assignment. The network computer system 100 can further monitor the progress of each freight operator towards fulfilling the current shipping assignment, including recording the current and/or recent locations of the freight operator with respect to the planned route of the freight operator. The network computer system 100 can track freight operators by, for example, (i) recording new shipping requests that are assigned to each freight operator; (ii) detecting when the freight operator loads the corresponding shipment of each shipping request; (iii) tracking a location of each freight operator that is assigned to a shipping request as the freight operator travels to a shipment loading location, and/or to a shipment delivery location; and/or (iv) detecting when the freight operator unloads or otherwise completes a current shipping assignment. Over time, the network computer system 100 can use historical information for each freight operator. The historical information can include, for example, parametric information about completed shipping requests, including shipment loading locations, shipment delivery locations, and routes taken by the freight operator. The network computer system 100 can also determine preferences of the freight operators as to shipping requests, such as preferred shipment pickup and/or delivery locations of each freight operator. Still further, in variations, the network computer system 100 can infer preferences of the freight operator as to shipping requests, based on, for example, a home location of the freight operator.

In variations, the network computer system 100 develops and maintains freight activity profiles 65 for individual freight operators. The network computer system 100 can develop the freight activity profiles 65 by monitoring individual freight operators over the course of a time interval where the respective freight operator is assigned to a corresponding shipping request, and further operates a freight vehicle to complete one or more shipping requests. Over time (e.g., as freight operators complete multiple shipping requests), the respective freight activity profiles 65 of the individual operators can more accurately reflect preferences or tendencies of the freight operators with respect to shipment pickup and/or delivery locations, preferred routes, the freight operator's home location, and other parameters.

Accordingly, the developed freight activity profiles 65 can record historical information about prior shipping assignments which individual freight operators have completed. Additionally, the freight activity profiles can identify information about the current shipping assignment which individual freight operators are completing, or initiating (e.g., traveling to loading location). In some examples, the freight activity profile 65 can reflect a state of a current shipping assignment which the freight operator is completing, including a current location of the freight operator, and an indicator or estimate of the arrival time of the freight operator at a delivery location. Thus, the freight activity profiles 65 can include information that reflects parametric information (e.g., pickup and delivery locations, route or lanes taken, estimated shipment completed time, etc.) for current shipping requests that the freight operators are fulfilling, as well as historical information for prior shipping requests which the freight operator fulfilled. Additionally, the freight activity profiles 65 can include other types of information that indicate a preference of the freight operator as to freight loading and/or delivery locations, as well as to routes and/or geographic regions for loading and/or delivering shipments. With respect to current assignments (e.g., in progress) and prior completed assignments, the freight activity profile 65 can also include information about current and past shipping assignments (e.g., load type or size), as well as information about the driving tendencies of the respective freight operator (e.g., consecutive interval of time during which the freight operator has been operating a corresponding freight vehicle).

In some examples, network computer system 100 receives shipping requests 112 from shippers (represented by shipper 12). The shipper 12 can include a user that operates a shipper device 22 to specify a load for transport from the shipper's site to a delivery destination. Each shipping request 112 can specify request parameters 113, such as load information (e.g., type of load, load identification), loading location, and delivery location. In variations, the shipping requests 112 can specify timing parameters (e.g., time interval specifying when loading can take place, a delivery time interval when the loaded load can be unloaded at the delivery location), freight vehicle type specifications, and/or other considerations.

The network computer system 100 implements a service to match freight operators to unmatched (e.g., new) shipping requests using the freight activity profiles 65 of the respective freight operators and the request parameters of the individual shipping requests 112. The system 100 can implement the matching service for shippers, in response to receiving new shipping requests 112. As an addition or variation, the network computer system 100 can implement the matching service for freight operators, in response to detecting an availability event for the freight operator.

According to examples, the network computer system 100 implements the matching service by categorizing available freight operators for individual shipping requests 112. The network computer system 100 can define one or more categorical designations that are based at least in part on a comparison of delivery parameters for a freight operator's current shipping assignment and the delivery location of the new or unassigned shipping request. Still further, the network computer system 100 can define one or more categorical designations that are based at least in part on comparisons of the loading location and/or delivery location of the freight operator's current assignment, and the shipment parameters of the new or unassigned shipping request. As an addition or variation, the network computer system 100 can define one or more categorical designations that are based at least in part on an aggregate analysis of the freight operator's prior assignments. The matching service can prioritize categorical designations for matching, such that freight operators that satisfy a particular categorical designation are weighted or favored to match to a corresponding shipping request 112. In this manner, the categorical designations can be used to promote objectives of (i) reducing the distance and/or duration of travel for freight vehicles in between carrying loads, and/or (ii) increasing the instances when freight operators are matched to a shipping request that matches a preference or promotes an objective of the freight operator. Moreover, as compared to conventional freight matching services, the network computer system 100 reduces the amount of computing and/or effort that would otherwise be required to match shipping requests to freight operators, as matched freight operators are more likely to accept a shipping request for assignment when the selection of the freight operator promotes an objective or preference of the freight operator.

According to examples, the network computer system 100 can determine the categorical designation for multiple freight operators, with respect to individual shipping requests, using the respective freight activity profiles 65 of each freight operator. In this manner, the determination of the particular match category designation for individual freight operators can further be specific to corresponding shipping requests. Thus, a given freight operator can be assigned to a first categorical designation when matching is performed for loads of a first shipper, and to a second categorical designation when matching is performed for loads of a second shipper. In this way, the network computer system 100 can implement the matching service to match freight operators to new or unassigned shipping requests 112 based on categorical designations that are determined for available freight operators.

In some examples, when network computer system 100 matches a freight operator to a new or unassigned shipping request 112, the matched freight operator receives a communication 75 (e.g., notification provided through the service application) that identifies the matched shipping request 112 to the freight operator. The communication 75 can, for example, identify the shipping request 112, including the request parameters of the shipping request (e.g., loading and delivery locations, type of load). The freight operator can elect to be assigned to the shipping request 112 through interaction with the freight operator's computing device 14 (e.g., via the service application of the respective computing device 24). In variations, the network computer system 100 can automatically assign the freight operator to the matched shipping request 112, and the communication 75 can communicate the assignment. In either of the examples, once the freight operator is assigned to the shipping request, the shipper has the responsibility of fulfilling the shipping request.

In examples in which the shipping service is triggered by activities of shippers, the network computer system 100 can respond to new and/or unassigned shipping requests 112 by determining a categorical designation for available freight operator. For example, shipper 12 can specify the shipping request 112 with corresponding request parameters, including loading location, delivery location, loading time, and/or delivery time. The network computer system 100 can perform the matching service to identify a candidate set of freight operators for a newly received or unassigned shipping request 112. The network computer system 100 can then send a communication 75 to each freight operator of the candidate set, and the newly received shipping request 112 is assigned to the freight operator that responds to the communication 75 with an acceptance. In this way, the network computer system 100 can recommend shipping requests 112 to freight operators based at least in part on the categorical designation that is determined for each freight operator.

In variations in which the matching service is triggered by activities of the freight operator, the network computer system 100 communicates with the computing devices 24 of active freight operators to detect availability events. The network computer system 100 can process freight activity information 52 transmitted from computing devices 24 to detect one or more types of availability events. In some examples, the availability events can be detected from user-interaction with the service application running on the respective computing device 24. By way of example, an availability event can correspond to an explicit request generated by the freight operator interacting with a user interface feature provided on the respective computing device. In variations, the availability event can be inferred from the freight operator's interactions with the computing device, such as the freight operator searching for new or unassigned shipping requests 112. In some variations, the network computer system 100 can detect availability events that coincide with a threshold measure of distance or time from when the freight operator completes an existing shipping request 112. For example, the network computer system 100 can detect when individual freight operators are within a threshold duration or distance of travel from completing their current shipping request.

In performing matching, the network computer system 100 categorizes individual freight operators into one of multiple possible match category designations. The network computer system 100 can categorize a group of freight operators based on request parameters of each shipping request 112 (e.g., loading location, delivery location, loading time), such that individual freight operators can be designated to different categories for different shipping requests. In variations, the network computer system 100 can weight, or otherwise prioritize categorical designations for new or unassigned shipping requests. By way of example, the network computer system 100 receives a new shipping request 112. The network computer system 100 can then select a set of candidate freight operators for the newly received shipping request 112, where each freight operator of the candidate set (i) satisfies criteria for one of multiple possible match category designations, and (ii) is deemed available at the loading time of the new shipping request 112. Each freight operator of the candidate set may then receive a communication 75 that serves as a recommendation for the freight operator. The freight operator can respond to the communication 75 with acceptance, and the new shipping request 112 is assigned to the freight operator.

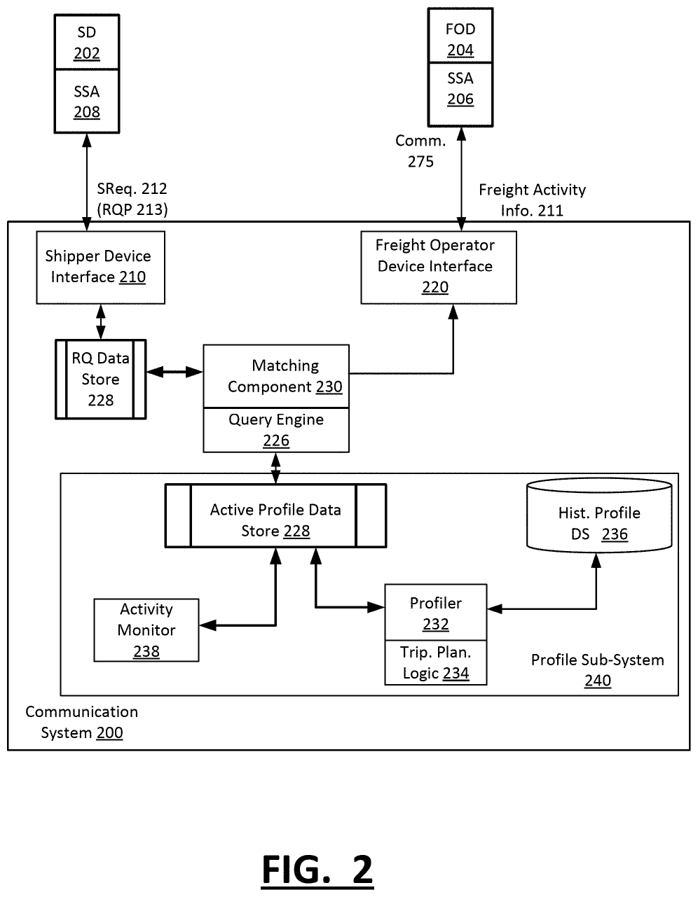

FIG. 2 illustrates a communication system for freight vehicle operation and assignment. With reference to an example of FIG. 2, the communication system 200 can be implemented by, for example, network computer system 100, to communicate with and match freight vehicles to shipping requests. Accordingly, the communication system 200 can be implemented by a server, or a combination of servers, which can communicate with shipper and freight operator devices over one or more networks. The communication system 200 can further utilize wireless networks, including cellular networks which utilize respective towers and base stations to link with mobile devices that can be carried on vehicles.

With further reference to an example of FIG. 2, the communication system 200 includes a shipper device interface 210, an operator device interface 220, and a matching component 230 and profile sub-system 240. The shipper device interface 210 can be implemented as a communication interface for shippers. In an implementation, the shipper device interface 210 provides a web-based portal or other form of programmatic interface, from which shippers can generate new shipping requests 212. In an example of FIG. 2, the shipper device interface 210 communicates with a shipper device 202 on which a shipper service application 208 executes. A shipper can, for example, interact with the service application 208 to generate a new shipping request 212. A new shipping request 212 can be specified with request parameters 213, including a loading time interval, a loading location where a new load can be loaded onto a freight vehicle, and a delivery location.

The operator device interface 220 communicates with mobile devices of freight operators (as represented by the operator device 204), on which respective service application 206 executes. The service application 206 can execute on the operator device 204 to, for example, automatically obtain and transmit various types of freight activity information 211. In some examples, the shipper device interface 210 and the operator device interface 220 can each include or use an application programming interface (API), such as an externally provider-facing API, to communicate data with the shipper device 202 and the operator device 204, respectively. By providing the externally facing API, the communication system 200 can establish secure communication channels via secure access channels over the network through any number of methods, such as web-based forms, programmatic access via RESTful APIs, Simple Object Access Protocol (SOAP), remote procedure call (RPC), scripting access, and/or other logic.

Through use of service application 206, a freight activity profile can be obtained and maintained, which tracks the freight operator even as the freight operator changes vehicles. Among other advantages, examples can develop and maintain freight activity profiles for independent freight operators, irrespective of the freight vehicle which the freight operator may operate at a given time.

In examples, the freight activity information 211 includes location data, which the service application 206 can obtain by interfacing with a satellite receiver (or other geo-aware resource) of the operator device 204. In this way, the operator device interface 220 can correlate, or otherwise determine a current location of the freight vehicle (or freight operator) based on the location data provided as part of the freight activity information 211. As an addition or variation, the service application 206 interfaces with other types of resources, such as one or more movement sensors (e.g., accelerometer, gyroscope) to determine movement information (e.g., via accelerometer sensor), as well as environmental sensors (e.g., barometer, thermometer) to determine respective types of environmental information (e.g., barometric information, temperature information, etc.). In variation, the freight activity information 211 also includes operator input, such as input from an operator searching for open shipping requests and/or an operator accepting a recommendation for a shipping request.

In examples, the service application 206 can identify the freight operator or carrier, as well as the freight vehicle that the freight operator is operating. As described with some examples, the service application 206 can communicate with an ELD of the freight vehicle to obtain a VIN or other identifier of the freight vehicle. In variations, the freight operator may capture an image or otherwise manually enter the identifier of the freight vehicle. In this way, the service application 206 can associate operator devices 204 with respective freight operators and freight vehicles, even in situations where the freight operator operates more than one freight vehicle over a given time frame.

In some variations, the service application 206 can execute on the operator device 204 to communicate with resources that are integrated with, or otherwise associated independently with the freight vehicle. In this way, the freight activity information 211 can include sensor information, user input, state information and/or other information which can be obtained and/or determined on the operator device 204. By way of example, the service application 206 may communicate with the ELD of the freight vehicle, to obtain ELD logging information, as well as vehicle telemetry information, such as engine state, odometer readings, and various types of sensor information of the vehicle.

As an addition or variation, the service application 206 may implement processes to determine, for example, the state of the freight vehicle or operator based on the data obtained from the ELD. Alternatively, the service application 206 can communicate the ELD information to the communication system 200 via the operator device interface 220. In turn, the communication system 200 can utilize the ELD information to determine the state of the freight vehicle or freight operator. Similarly, the service application 206 can communicate with sensors that are integrated or otherwise provided with the trailer, tires, or other components of the freight vehicle. Processes of the service application 206 and/or communication system 200 can utilize sensor information to determine, for example, whether the freight vehicle is available to carry an additional load based on an estimated size or weight of an existing load carried within the trailer of the freight vehicle.

In an example of FIG. 2, the operator device interface 220 can communicate with the operator device 204 via the service application 206 to receive updated freight activity information 211. The updated freight activity information 211 can identify, for example, a recent or current location of the freight operator, a route that the pertaining to the freight vehicle that a respective freight operator is operating, a status of the freight operator's current assignment, a status of the freight operator (e.g., freight operator resting) and other types of information.

The profile sub-system 240 can be used to store and manage the freight activity information 211. The operator device interface 220 can store the freight activity information 211 in an active profile data store 228, which the operator device interface 220 updates through communications with multiple active freight operators in a given territory or region. For example, the operator device interface 220 can update a record associated with the freight operator or vehicle, based on the freight activity information 211. The operator device interface 220 can also record, with the active profile data store 240, updated location information (e.g., current location) provided by multiple operator devices, for respective freight vehicles that are operated within a territory or given geographic region.

In variations, the operator device interface 220 can also record relevant profile information along with updated information for individual freight operators. In this way, the record that is associated with each freight operator can identify a current location of the respective freight vehicle, as well as other information determined from the active profile data store 228. For example, the operator device interface 220 may associate a capability of the freight vehicle with the associated record of the respective freight operator.

The shipper device interface 210 can communicate with the shipper device 202 (or shipper interface) to receive a new shipping request 212. The shipping request 212 can specify parameters such as a load location and a delivery location. The shipping request 212 can also specify a pickup time or time interval, as well as a delivery time or time interval when the load is to be delivered at the delivery location.

The profile sub-system 240 includes an active profile data store 228, a profiler 232, and a historical profile store 236. The active profile data store 228 can be structured to associate profile records with individual freight operators, and the operator device interface 220 can update the profile records using the freight activity information 211 received from the operator devices 204. The operator device interface 220 can record the current shipping assignment of each freight operator with respective profile record(s), over a duration in which the freight operator fulfills one or more shipping requests. The profile record for each freight operator may reflect, for example, the communication system 200 matching the freight operator to a shipping request, and the freight operator accepting assignment of the shipping request. Each freight operator can be associated with a record that associates an identifier of the freight operator with the current shipment that is assigned to the freight operator. The record for the current shipment that is assigned to each freight operator can further include the loading location where the freight operator loaded the current shipment, and the delivery location where the freight operator is to deliver the current shipment. In some examples, the profile record for individual freight operators can also include the current shipment can also include the expected delivery time for the freight operator's shipment. The expected delivery time can be determined from, for example, the shipper's specification for the delivery time.

A new shipping request 212 can be received by the shipper device interface 210 and stored in a request data store 208. For example, the request data store 218 can include a cache, queue or other data structure that retains data identifying open or unassigned shipping requests 212, including request parameters 213 that may be specified with the respective shipping requests 212. The matching component 230 can perform a matching service to match open shipping requests 212 of the request data store 218 with a candidate set of freight operators. In some examples, each freight operator of the candidate set receives a communication 275 that recommends the freight operator for assignment to one of the open shipping requests 212. When multiple freight operators are included in the candidate set, the communications 275 can be transmitted at one time, or by a sequence based on a priority designation that is associated with the freight operator. For a given shipping request 212, the freight operator that receives the communication 275 can respond with acceptance or rejection of the assignment. The acceptance can be by way of a communication that is communicated from the operator device 204, through the operator device interface 220. When one of the candidate set of freight operators accepts assignment to a respective shipping request 212, the matching component 230 can update the shipping request data store 218 to reflect the respective shipping request 212 has been assigned. The matching component 230 can also update the active profile data store 228 to reflect the freight operator's new assignment, including the request parameters 213 of the newly assigned shipping request 212.

In variations, the profiler 232 can implement trip planning logic 234 to estimate the delivery time for the freight operator's current estimate. For example, the profiler 232 can implement the trip planning logic 234 to estimate the delivery time for a freight operator's current assignment, based on the current location and status of the freight operator, as provided by the profile record of the respective freight operator. In some variations, the profiler 232 can also estimate the delivery time of the freight operator based on a remaining amount of a designated time interval during which the freight operator can continue to operate the freight vehicle without a required or recommended rest period. Still further, the profiler 232 can implement the trip planning logic 234 to predict a route, or portion thereof, which the freight operator may take to complete a current shipping assignment.

In examples, the profiler 232 can also update a historical profile of each freight operator, as maintained with the historical fright profile data store 236, to reflect, for example, completion of individual shipping assignments. Over time, the historical profile of each freight operator, as maintained by the historical freight profile data store 236, can include aggregate information that can identify, for example, the preferences of individual respective freight operators with respect to shippers, loading locations, delivery locations and/or types of loads.

The matching component 230 can match open shipping requests (e.g., as stored in the request data store 218) to freight operators using the active profile data store 228 and/or the historical profile store 236. In examples, the matching component 230 can include a query engine 226 that queries the respective profile stores 228, 236 for criteria that define respective match categorical designations. The query engine 226 can utilize a set of definitions for match categorical designations that include, for example, one or more of a backhaul designation, an identical load designation, a reload designation, a relay designation, a historical designation, and/or a home designation. In such examples, a backhaul designation can be defined by criteria of (i) the delivery location of the freight operator's current assignment being within a threshold distance or duration of travel to the loading location of the respective open shipping request 212, and (ii) the delivery location of the respective open shipping request 212 being within a threshold distance or duration of travel from a loading location of the freight operator's current assignment. An identical shipment designation can be defined by criteria of (i) the loading location of the freight operator's current assignment being within a threshold distance or duration of travel from a loading location of the respective open shipping request, and (ii) the delivery location of the freight operator's current assignment being within a threshold distance or duration of travel from a delivery location of the respective open shipping request. A reload designation can be defined by criteria of the loading location of the respective shipping request 212 being within a threshold distance or duration of travel from a loading location of the freight operator's current assignment. A relay designation can be defined by criteria of the loading location of the new shipment being within a threshold distance of a current or planned route of the freight operator. A historical designation can be defined by criteria where the loading location, delivery location, and/or route of an open shipping request being deemed sufficiently equivalent to prior shipping requests which the freight operator fulfilled. The home designation can be defined by criteria of the loading location, delivery location or route (or portion thereof) being within a given geographic region that is the freight operator's home or preferred location. In variations, the various threshold values that are used to determine the categorical designations can be dynamically determined, based on factors such as the number of open shipping requests.

In some examples, the match category designations can be prioritized, such that freight operators that satisfy a highest ranked categorical designation for a particular shipping request 212 are more likely to be assigned to the shipping request. To reduce deadhead freight vehicle operation, for example, the matching component 230 can implement a prioritization scheme in which the backhaul designation has the highest priority (e.g., freight operator is assigned to a shipment that returns the freight operator to a home or starting location of a current shipping assignment), followed by the reload designation and/or relay designation (e.g., new shipment represents stop along or near current route of freight operator). In variations, however, different match category designations can be prioritized as between successive shipping requests, to better distribute shipping requests 212 amongst a population of freight operators, and to ensure objectives underlying other match categorical designations (e.g., operator preferences as to routes or shipment delivery locations) are also met.

According to some examples, the matching component 230 can utilize one or multiple selection protocols to select a candidate set of freight operators for an open shipping request 212. In some variations, the matching component 230 filters the candidate set of freight operators for availability with respect to a particular shipping request. In one implementation, the matching component 230 can process, for example, the freight operator's record from the active profile data store 228 to determine the freight operator's current status. For freight operators who are fulfilling a current shipping assignment, the matching component 230 can implement the trip planning logic 234 to predict a delivery time of that freight operator's current shipping assignment. As an addition or variation, the matching component 230 can predict the travel time from the delivery location of the freight operator's current shipping assignment to the loading location of the open shipping request 212 under consideration. In this way, the matching component 230 can predict whether a freight operator that is completing a current shipping assignment can arrive at the loading location of a new or unassigned shipping request.

In examples, the matching component 230 can make the selection of the candidate set of available freight operators from, for example, the active profile data store 228 and/or the historical profile data store 236. For example, the matching component 230 can use the query engine 226 to identify N available freight operators, beginning with available freight operators that satisfy the highest ranked categorical designation (e.g., backhaul designation). If the number of freight operators that match the highest ranked categorical designation is less than N, then the matching component 230 can use the query engine 226 to identify freight operators that satisfy the next highest ranked categorical designation. The identification of N available freight operators can represent the candidate set of freight operators for a given shipping request. The matching component 230 can initiate a communication 275 to each of the freight operators of the candidate set, where the communication 275 recommends the shipping request to the freight operator.

In such examples, the communication 275 can be communicated to each of the freight operators of the candidate set at one time. In variations, the communication 275 can be communicated to individual freight operators in a staggered or sequenced fashion. For example, those freight operators of the candidate set who are provided the match category designation with the highest priority or ranking can be provided the communication 275 first in time, to favor their selection for the particular shipping request. After a given period of time (e.g., minutes or hours later), the communication 275 can be communicated to those freight operators of the candidate set who are part of the next highest prioritized or ranked match category designation. The shipping request can then be assigned to the first freight operator of the candidate set who accepts the recommendation.

While some examples as described implement the matching in response to open shipping requests, in variations, the matching component 230 can also match open shipping requests to freight operators that are detected as being available. The operator device interface 220 can include logic to detect availability events from the freight activity information 211. The availability event can coincide with a determination that the freight operator is available for assignment to an open shipping request, or alternatively, that the freight operator will be available for assignment in an upcoming time interval (e.g., within the next 24 hours). Accordingly, the operator device interface 220 can process the freight activity information 211 to detect availability events that coincide with operator input, such as the operator requesting to see available freight loads in a given region, or the freight operator performing a search for freight loads. Alternatively, an activity monitoring component 238 analyzes the active profile data store 228 to determine when, for example, the freight operator has met a threshold or marker for completing the freight operator's current assignment. By way of example, the threshold or marker can coincide with the freight operator being within a distance or duration of travel to the delivery location of the freight operator's current assignment. The occurrence of the freight operator meeting the threshold or marker can be deemed an availability event, signifying that the freight operator will be available in a future time interval (e.g., at the expected time of delivery for the freight operator's current assignment).

In some examples, when the availability event is detected, the matching component 230 can seek to match the freight operator to one of the multiple match category designations. If, for example, the freight operator meets a match category designation for a particular shipping request 212 that has the highest priority, the matching component 230 can match the freight operator to that shipping request 212. When matched, some examples provide that the freight operator can receive a communication 275 that recommends the identified shipping request 212 to the freight operator, and the freight operator can respond affirmatively to the communication to be assigned to the shipping request. In other examples, the freight operator can be automatically assigned to the identified shipping request, such that the communication 275 confirms the assignment of the freight operator to the identified shipping request 212.

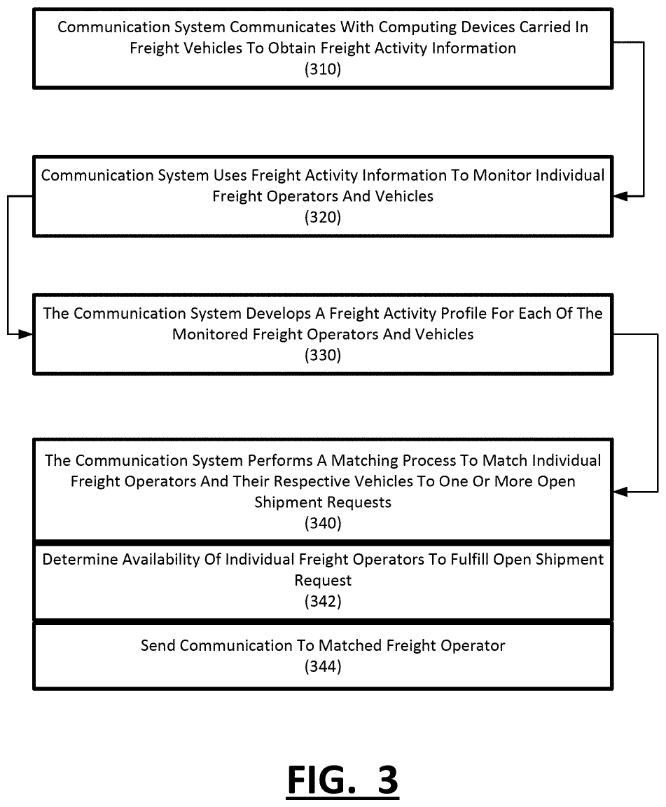

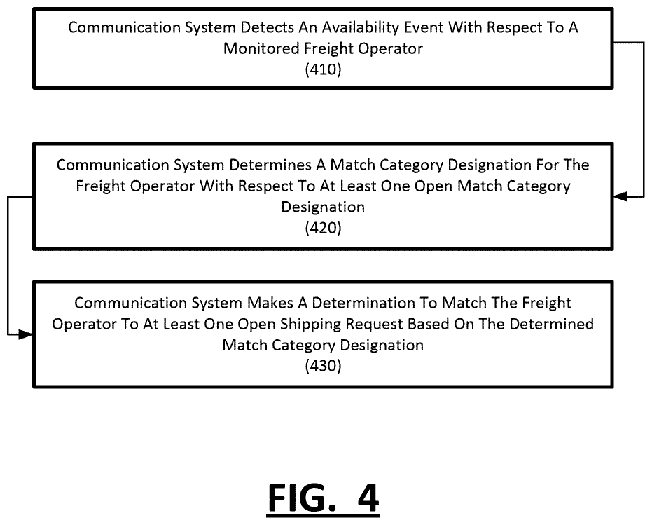

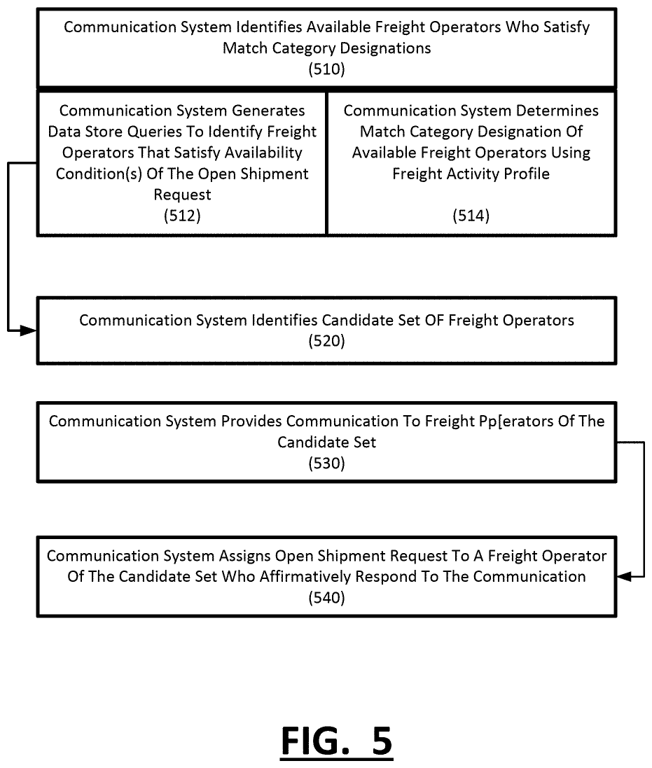

FIG. 3 illustrates an example method for matching freight operators to shipping requests. FIG. 4 illustrates a method for matching a freight operator that is detected as being available with an open shipping request. FIG. 5 illustrates a method for matching an open shipping request to a candidate set of freight operators. In describing examples of FIG. 3-5, reference may be made to elements of FIG. 2, for purpose of illustrating suitable components for performing a step or sub-step being described.

With reference to an example of FIG. 3, the communication system 200 communicates with computing devices carried in freight vehicles to obtain freight activity information (310). In examples, the communication system 200 communications with computing devices 204 of individual freight operators, which can be linked to respective freight vehicles under operation. For each freight operator, the respective operator device 204 can execute a corresponding service application that transmits freight activity information 211 to the communication system 200. The freight activity information 211 can be programmatically retrieved, under control of the communication system 200. The communication system 200 can retrieve the freight activity information 211 through use of the service application 206, running on the computing devices 204 that are carried within the freight vehicles. The freight activity information can include, for example, location information (e.g., such as obtained from a satellite receiver on the freight operator's computing device 204) that identifies a recent (e.g., most current) location of the freight operator. In further examples, the freight activity information can include data generated from the operator's interaction with the respective operator device 204, such as through a user-interface generated on the freight operator's computing device. The data transmitted to the communication system 200 can include, for example, the freight operator's responses to communications from communication system 200, which recommend shipping requests to the freight operator. For example, transmitted data can include the freight operator accepting or rejecting assignment to a recommended shipping request. In variations, the transmitted data can include searches that the freight operator performs, using the service application 206, for shipping requests or loads which await transport, navigation information (e.g., freight operator enters destination and receives route information), and/or feedback provided by the freight operator with respect to a recent shipping request that has been assigned to the freight operator and/or which the freight operator has fulfilled.

In other examples, the freight activity information 211 can include sensor information retrieved from sensors that are local to the respective computing device or freight vehicle of the freight operator. By way of example, the sensor information can include data read from motion sensors, such as provided by an accelerometer and/or gyroscope, to indicate vehicle acceleration (e.g., vehicle stopping or turning).

For example, the freight activity information 211 can include data obtained from devices that are external to the freight operator's computing device. For example, the service application 206 can be configured to control processes on the freight operator's computing device 204, to cause the computing device to interface and read data from, for example, an electronic logging device of the freight vehicle, vehicle sensors and/or trailer sensors. In such examples, the freight activity information 211 can include, for example, (i) logging data, which indicates the time intervals during which the freight operator has operated the freight vehicle, and (ii) load data (e.g., from trailer sensors), indicating a weight or size of a current load, as well as the free and/or occupied space of the trailer.

In some examples, the communication system 200 uses the freight activity information 211 to monitor the individual freight operators and their respective vehicles, over a duration in which the freight operator operates a freight vehicle to fulfill one or more shipping requests (320). The system can record a set of request parameters for each shipping request that the freight operator is fulfilling, or has fulfilled, including a loading and delivery location of each shipping request. As an addition or variation, the set of recorded parameters can include the type of load, the route the freight operator has taken, and/or the locations where the freight operator has stopped.

According to the example of FIG. 3, the communication system 200 develops a freight activity profile for each of the monitored freight operators and vehicles (330). The developed freight activity profiles can be based on request parameters of shipping requests that the freight operator is fulfilling or has fulfilled, as well as freight activity information 211 obtained from the respective computing device of the freight operator while the freight operator fulfills a current assignment (e.g., operates the respective freight vehicle towards fulfillment of the shipping request that is currently assigned to the freight operator). In examples, the freight activity profile of each freight operator can include, or is otherwise based on parametric information about a current assignment of the freight operator. The parametric information can include request parameters (e.g., loading location, delivery location, delivery time interval, etc.) of the freight operator's assignment. The parametric information used to develop the respective freight activity profiles of the individual freight operators can also identify a current status of the freight operator, such as an estimated time of arrival for the freight operator to the delivery location of the freight operator's current assignment. The freight operator's current status can also include, for example, the amount of time remaining during which the freight operator can continue to operate the freight vehicle without violating a rule that otherwise limits the duration of time in which the freight operator can operator such vehicles.

The communication system 200 can perform a matching process to match individual freight operators and their respective vehicles, to at least one of multiple open shipping requests based on the freight activity profile developed for that freight operator, as well as one or more request parameters of the open shipping request (340). In performing the matching process, the communication system 200 can determine an availability of individual freight operators to fulfill an open shipping request, such as through a newly received transport request (342). The determination can be based on the respective freight activity profiles, and more specifically, on the status of the freight operator's current assignment.

In some examples, the communication system 200 determines the availability of the individual freight operators by determining an estimated time of delivery for the freight operator to complete his or her current assignment. The communication system 200 can also determine the availability of the freight operator by estimating a duration of time for the freight operator to travel from the delivery location of the freight operator's current assignment to the loading location of the open shipping request.

As an addition or variation, the communication system 200 can detect availability events amongst monitored freight operators, and further mark the freight operator as available in response to detecting the availability event. In examples, the availability events can coincide with freight activity information 211 that indicates the freight operator is available or will become available in an upcoming time interval. The detection of the availability event can identify a time period when the freight operator is or will be available, as well as a geographic region of the freight operator during that time interval. By way of example, the freight operator can search for open shipping requests (e.g., using the service application 206, running on the respective device of the freight operator), and the communication system 200 can detect the search as an availability event based on the search parameters. For example, the freight operator can search for open shipping requests by specifying a time period and/or region. As another example, if the freight operator specifies a geographic region when searching for open shipping requests, the communication system 200 can detect the freight operator as being available for assignment to shipping requests that originate from that geographic region. Additionally, the communication system 200 can calculate the time interval of the freight operator's availability to account for the freight operator's time of travel. Moreover, the time interval of availability can be directly determined, such as from the freight operator's current location, or indirectly determined, such as through a destination location of the freight operator's current assignment.

In variations, an availability event can coincide with the communication system 200 identifying when monitored freight operators achieve a milestone that is indicative of the freight operator being available in an upcoming duration of time to fulfill an open transport request. By way of example, communication system 200 can monitor the location of a given freight operator to detect when the freight operator is within a threshold distance or time of travel from the delivery location of the freight operator's current assignment. The threshold duration and/or distance can be predetermined or determined based on parameters of the open shipping request. For example, a new shipping request which specifies a loading time of “next day” may cause communication system 200 to identify freight operators who are expected to fulfill their current assignment at a delivery location that is within a designated range of the loading location of the new shipping request, and by a given time that precedes a specified loading time of the new shipping request.

In examples, the matching process can be performed periodically to identify open shipping requests and freight operators that are available for identified shipping requests. As a variation, the matching process can be performed in response new shipping requests, to identify freight operators that are available, or likely will be available, given the loading time and location specified with the shipping request. As another variation, the matching process can be performed in response to detecting an availability event for individual freight operators. For example, communication system 200 can detect a given freight operator performing a search, or nearing a marker that designates completion, or near completion of an assigned shipping request.

In performing the matching process, the communication system 200 can also send a communication to a freight operator that is matched to an open shipping request (344). By way of example, the communication can be a notification, or an in-app communication generated from within the service application of the freight operator. In some examples, the communication can be a recommendation. As a recommendation, the freight operator may be one of a candidate set of freight operators who can elect or otherwise be assigned to the matched service request. In variations, the communication can reflect an assignment of the freight operator to the matched shipping request.

With reference to an example of FIG. 4, the communication system 200 can detect an availability event with respect to a monitored freight operator (410). As described with other examples, the availability event can correspond to, for example, (i) an activity of the freight operator (e.g., search operation) with respect to the service application, where the activity is indicative of the freight operator being currently available, or available in an upcoming time interval; and/or (ii) the freight operator achieving a milestone with respect to a current shipping assignment, where the milestone is indicative of the freight operator nearing completion shipping assignment.

In response to detecting the availability event, the communication system 200 can determine a match category designation for the freight operator with respect to at least one open shipping request (420). In some examples, the communication system 200 identifies multiple open shipping requests, and the matching component 230 determines a match category designation for the freight operator with respect to each of the multiple open shipping requests. As described with other examples, each match category designation can be based on the freight activity profile of the freight operator, including the current shipping assignment of the freight operator, as well as the request parameters of the open shipping requests. As an addition or variation, the open shipping request(s) can be selected based on a determination that the time interval of the freight operator's availability precedes the loading time of the open shipment request.

According to some examples, the communication system 200 makes a determination to match the freight operator to at least one open shipping request based on the determined match category designation (430). If multiple open shipping requests are available to the freight operator, the open shipping request with the highest rank may be selected from the determination.

In some examples, the freight operator is matched to a shipping request based on the match category designation. For example, the communication system 200 may match the freight operator to the open shipping request if the freight operator has a backhaul, reload designation or relay designation. If the freight operator is not matched to one of the open shipping requests, the freight operator may be matched to an open shipping request at a later time, using, for example, a process such as described with an example of FIG. 3. Thus, an example of FIG. 4 can be used to match a freight operator to an open shipping request when there is an immediate shipping request for which specific objectives of one or more of the match category designations are met. For example, the communication system 200 can operate to promote matching of open shipping requests to freight operators who satisfy the backhaul, reload or relay designations because such designations promote efficiency with respect to freight vehicle usage, as well as freight operator's time and resources.

With reference to an example of FIG. 5, communication system 200 can implement a bucket-based matching process for open shipping requests. For an open shipping request, the communication system 200 can identify available freight operators who satisfy each match category designation of multiple possible match category designations (510). The defined match category designations can be ranked, meaning that, for an open shipping request, freight operators who satisfy higher ranked match category designations are more likely to be matched to the open shipping request.

According to examples, the matching component 230 queries the active profile data store 228 for freight operators that satisfy an availability condition of the open shipping request (512). The availability conditions can be based on parameters that include the expected delivery time and delivery location of the current assignment of the individual freight operators. Additionally, the availability condition can be based on the loading location and loading time interval of the open shipping request. In order to determine available freight operators, the matching component 230 can implement logic that makes a determination, for each queried freight operator, as to whether the freight operator's estimated delivery time for the freight operator's current assignment sufficiently precedes the time interval for loading the load of the open shipping request, while allowing the freight operator to travel from the destination location of the current assignment to the loading location of the open shipping request.

The freight activity profile of each available freight operator (e.g., freight operator satisfies availability conditions for open shipping request) can further be analyzed to identify a match category designation (514). The match category designations can be defined by respective criteria, which can be based in part on parameters of the open shipping request. By way of example, the match category designations can include a backhaul designation, reload designation, relay designation, identical shipment designation, preference designation and/or home designation.

For a given shipping request, N freight operators can be identified for a candidate set (520), where the size of N can be based on implementation. To identify N freight operators, the matching component 230 can identify each freight operator that satisfies the highest ranked categorical designation (e.g., backhaul designation). N may be selected to be greater than the number of freight operators that satisfy the highest ranked categorical designation, in which case freight operators of the next highest ranked categorical designation may be selected. The selection of freight operators can continue for each categorical designation until N freight operators are identified.

In variations, a portion (M) of the N freight operators of the candidate set can be force selected from designated categories. For example, M freight operators can be randomly selected from categorical designations that are lesser ranked (e.g., reload designation, preference designation).

Still further, in other examples, a designation portion of the N freight operates can be randomly selected from each match category designation. In variations, the match category designations can be ranked, to allot for more freight operators to be selected from the higher ranked match category designations if available.

In examples, each of the freight operators of the candidate set can be provided a communication (e.g., notification), to inform freight operator of the open shipping request (530). In examples, the communications to the freight operators can be staggered, or sequenced, based on the respective match category designation of the individual freight operators of the candidate set.

In examples, an open shipping request can be assigned to a freight operator of the corresponding candidate set who affirmatively responds to the communication (540). For example, the freight operator of the candidate set who is first-in-time to respond to the communication is assigned to the open shipping request. Once assigned, the freight operator is responsible for fulfilling the shipping request.

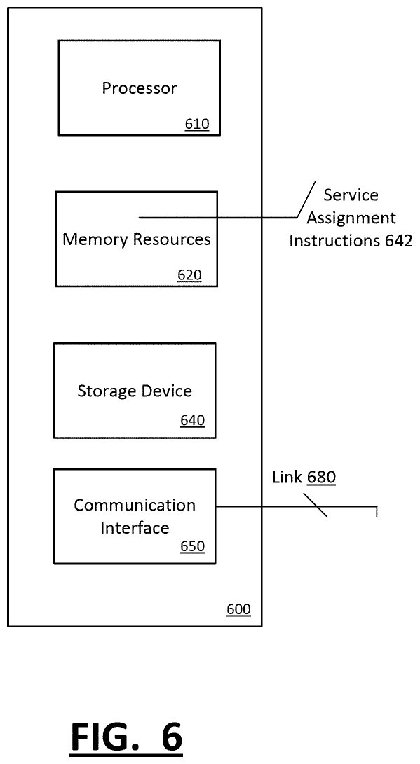

FIG. 6 illustrates a block diagram for a computer system on which examples described herein may be implemented. For example, in the context of FIG. 1 and FIG. 2, network computer system 100 and/or communication system 200 may be implemented using a computer system or combination of computer systems, such as described by FIG. 1 or FIG. 2.

In one implementation, the computer system 600 includes one or more processors 610, memory resources 620, and a communication interface 630. The computer system 600 includes at least one processor 610 for processing information. The memory resources 620 may include a random access memory (RAM) or other dynamic storage device, for storing information and instructions to be executed by the processor(s) 610. The memory resources 620 also may be used for storing temporary variables or other intermediate information during execution of instructions to be executed by the processor(s) 610. The computer system 600 may also include other forms of memory resources, such as static storage devices for storing static information and instructions for the processor 610. The memory resources 620 can store information and instructions, including instructions 542 for matching freight operators to minimize extraneous costs associated with travelling to the site of the new freight loads for shipment. Additionally, the processor(S) 610 can execute the instructions 642 to implement a method such as described with examples of FIG. 3, FIG. 4 and/or FIG. 5.

The communication interface 630 can enable the computer system 600 to communicate with one or more networks 680 (e.g., cellular network) through use of the network link (wireless or wireline). Using the network link, the computer system 600 can communicate with one or more other computing devices and/or one or more other servers or data centers. In some variations, the computer system 600 can receive device data and/or service-specific information from operator devices (e.g., operator device 204) and shipper devices (e.g., shipper device 202) via the network 680 to profile development and categorization of freight operators, as well as matching of freight operators to new shipping requests.

Examples described herein are related to the use of the computer system 600 for implementing the techniques described herein. According to one embodiment, those techniques are performed by the computer system 600 in response to the processor 610 executing one or more sequences of one or more instructions contained in the memory resource 620. Such instructions may be read into the memory resources 620 from another machine-readable medium, such as the storage device. Execution of the sequences of instructions contained in the memory resources 620 causes the processor 610 to perform operations and steps, as described herein. In alternative implementations, hard-wired circuitry may be used in place of or in combination with software instructions to implement examples described herein. Thus, the examples described are not limited to any specific combination of hardware circuitry and software.

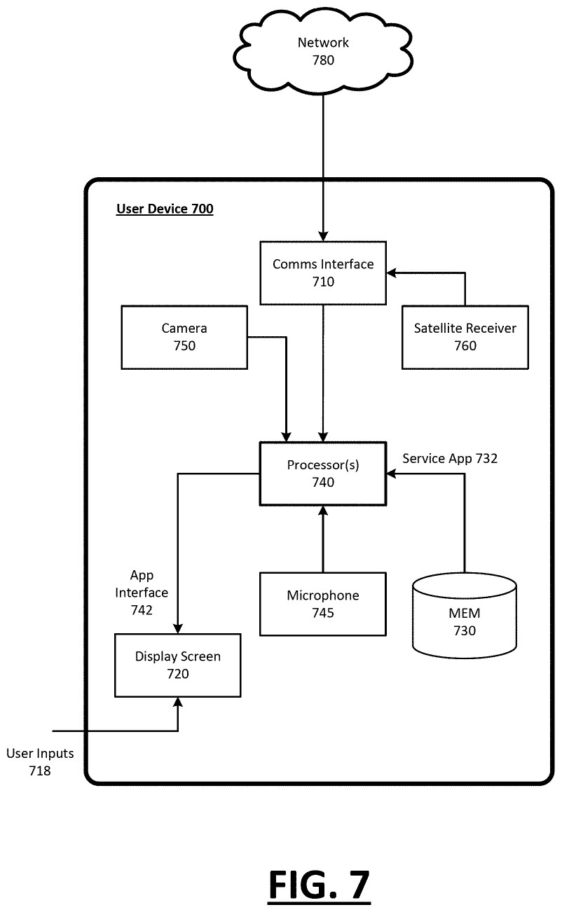

FIG. 7 illustrates a computing device for use with one or more examples as described. In one embodiment, a computing device 700 may correspond to a mobile computing device, such as a cellular device that is capable of telephony, messaging, and data services. The computing device 700 can correspond to a device operated by a freight operator. Examples of such devices include smartphones, handsets, tablet devices, or in-vehicle computing devices that communicate with cellular carriers.

The computing device 700 includes a processor 710, memory resources 720, a display device 730 (e.g., such as a touch-sensitive display device), one or more communication sub-systems 740 (including wireless communication sub-systems), one or more sensors 750 (e.g., accelerometer, gyroscope, barometer, altimeter, microphone, camera), and one or more location detection mechanisms (e.g., GPS component) 770. In one example, at least one of the communication sub-systems 740 sends and receives cellular data over data channels and voice channels. The communications sub-systems 740 can include a cellular transceiver and one or more short-range wireless transceivers. The processor 710 can exchange data with a service arrangement system (not illustrated in FIG. 7) via the communications sub-systems 740.

The processor 710 can implement operations by executing instructions stored in the memory resources 720. The memory resources 720 can also store instructions for the service application 725. For example, the processor 710 may be configured with software and/or other logic to perform one or more processes, steps, and other functions described with mobile computing devices of occupants of vehicles. In particular, the processor 710 can execute instructions and data stored in the memory resources 720 in order to execute a service application, such as described with various examples. In one example, the processor 710 may execute instructions of the service application 725 to communicate and receive messages, notifications, service-specific information, and other data exchanged between the computing device 700 and the communication system 200. The service application 725 may enable, for example, the freight operator to perform search operations, and to receive notifications which recommend a shipping request to the freight operator. As an additional example, the service application 725 can enable the freight operator to respond to notifications of open shipping requests, in order to receive assignment of the shipping request 725.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

1-20. (canceled)

21. A computing system comprising:
one or more processors;
one or more memory resources to store a set of instructions that, when executed by the one or more processors, cause the computing system to perform operations, the operations comprising:
obtaining, from one or more data stores accessible by the computing system, parameters associated with a plurality of open shipping requests;
obtaining, (i) over one or more networks, location data that identifies a location of a computing device of a freight operator, and (ii) by accessing the one or more data stores, historical freight data associated with the performance of a past shipping request by the freight operator;
determining that the freight operator is available for assignment to at least one respective open shipping request of the plurality of open shipping requests during an upcoming time interval;
determining a ranking of the freight operator based, at least in part on, on (i) the plurality of open shipping requests, (ii) the location of the computing device of the freight operator, and (iii) the historical freight data; and
based on the ranking, transmitting, over the one or more networks, a communication to the computing device of the freight operator that identifies the at least one respective open shipping request as a match for the freight operator.

22. The computing system of claim 21, wherein the parameters associated with the plurality of open shipping requests are viewable via a service application on the computing device of the freight operator.

23. The computing system of claim 21, wherein the communication comprises application content comprising a message indicative of the freight operator matching the at least one respective open shipping request.

24. The computing system of claim 21, wherein the communication comprises one or more parameters of the at least one respective open shipping request of the plurality of open shipping requests.

25. The computing system of claim 24, wherein the parameters associated with the plurality of open shipping requests comprise at least one of: (i) a load location, (ii) a delivery location, or (iii) a type of load.

26. The computing system of claim 21, the operations further comprising:
obtaining, over the one or more networks, data indicative of the freight operator electing to be assigned to a shipping request.

27. The computing system of claim 21, the operations further comprising:
Obtaining, from the one or more data stores, data indicative of a preference of the freight operator;
automatically matching the freight operator to the at least one respective open shipping request of the plurality of open shipping requests based on the data indicative of the preference of the freight operator; and
transmitting, over the one or more networks, a communication comprising instructions for completion of the respective open shipping request to the computing device of the freight operator.

28. The computing system of claim 21, wherein the historical freight data comprises preferences of the freight operator with respective to at least one of (i) shippers, (ii) loading locations, (iii) delivery locations, or (iv) types of loads.

29. A computer implemented method comprising:
obtaining, from one or more data stores accessible by the computing system, parameters associated with a plurality of open shipping requests;
obtaining, (i) over one or more networks, location data that identifies a location of a computing device of a freight operator, and (ii) by accessing the one or more data stores, historical freight data associated with the performance of a past shipping request by the freight operator;
determining that the freight operator is available for assignment to at least one respective open shipping request of the plurality of open shipping requests during an upcoming time interval;
determining a ranking of the freight operator based, at least in part on, on (i) the plurality of open shipping requests, (ii) the location of the computing device of the freight operator, and (iii) the historical freight data; and
based on the ranking, transmitting, over the one or more networks, a communication to the computing device of the freight operator that identifies the at least one respective open shipping request as a match for the freight operator.

30. The method of claim 29, further comprising matching the freight operator to an open shipping request based on at least one of: (i) one or more freight operator preferences, (ii) an availability event, (iii) one or more match category designations for each open shipping request of the plurality of open shipping requests.

31. The method of claim 30, wherein the one or more freight operator preferences comprise at least one of: (i) a shipment pickup location, (ii) a shipment delivery location, (iii) a preferred route, or (iv) a freight operator home location.

32. The method of claim 30, wherein the availability event is determined based on at least one of: (i) a freight operator current location, (ii) a current route, (iii) a destination associated with a current route, (iv) a point of origin associated with the current route, or (v) a home location.

33. The method of claim 30, wherein match category designations for each open shipping request of the plurality of open shipping requests comprises at least one of: (i) a backhaul designation, (ii) an identical shipment designation, (iii) a reload designation, (iv) a relay designation, (v) a historical designation, or (vi) a home designation.

34. The method of claim 33, wherein the backhaul designation is based on (i) a delivery location of a current shipping assignment that the freight operator is fulfilling being within a first threshold distance of a loading location of the at least one respective open shipping request; and (ii) a delivery location of the at least one respective open shipping request being within a second threshold distance of a loading location of the current shipping assignments.

35. The method of claim 33, wherein the identical shipment designation comprises at least some request parameters of the at least one respective open shipping request being equivalent to corresponding parameters of a previous shipping assignment that the freight operator fulfilled.

36. The method of claim 33, wherein the reload designation is based on a delivery location of a current shipping assignment that the freight operator is fulfilling being within a first threshold distance of a loading location of the at least one respective open shipping request.

37. The method of claim 33, wherein the home designation comprise designation in which at least one of a delivery location or loading location of the at least one respective open shipping request is within a home area of the freight operator

38. The method of claim 33, wherein a first highest priority is associated with a shipment designated as the backhaul designation for the respective freight operator, wherein a second highest priority is associated with the reload designation for the respective freight operator, and wherein a third highest priority is associated with the relay designation for the respective freight operator.

39. The method of claim 38, further comprising:
ranking of each respective open shipping request of the set of open shipping requests based on a priority associated with the respective shipping request relative to the freight operator;
transmitting, over the one or more networks, a first communication to a first set of freight operators comprising at least the freight operator, wherein the first communication comprises an offer for first open shipping request, wherein the first open shipping request is designated as the backhaul designation for each freight operator of the first set of freight operators;
determining a period of time has passed without receiving an acceptance of the open shipping request from the first set of freight operators; and
in response to determining the period of time has passed without receiving the acceptance of the open shipping request from the first set of freight operators, transmitting, over the one or more networks, a second communication to a second set of freight operators, wherein the second communication comprises an offer for the first open shipping request, wherein the first open shipping request is designated as the reload designation for each freight operator of the second set of freight operators.

40. One or more non-transitory computer readable media storing instructions that are executable by one or more processors to perform operations comprising:
obtaining, from one or more data stores accessible by the computing system, parameters associated with a plurality of open shipping requests;
obtaining, (i) over one or more networks, location data that identifies a location of a computing device of a freight operator, and (ii) by accessing the one or more datastores, historical freight data associated with the performance of a past shipping request by the freight operator;
determining that the freight operator is available for assignment to at least one respective open shipping request of the plurality of open shipping requests during an upcoming time interval;
determining a ranking of the freight operator based, at least in part on, on (i) the plurality of open shipping requests, (ii) the location of the computing device of the freight operator, and (iii) the historical freight data; and
based on the ranking, transmitting, over the one or more networks, a communication to the computing device of the freight operator that identifies the at least one respective open shipping request as a match for the freight operator.
